(19) United States
(12) Patent Application Publication
(10) Pub. No.: US 2014/0222414 A1
(43) Pub. Date: Aug. 7, 2014

(54) MESSAGING TRANSLATOR

(71) Applicant: Alfredo Reviati, Weston, FL (US)

(72) Inventor: Alfredo Reviati, Weston, FL (US)

(21) Appl. No.: 13/762,286

(22) Filed: Feb. 7, 2013

(51) Int. Cl. G06F 17/28

(52) U.S. Cl. CPC G06F 17/289
USPC 704/3

(57) ABSTRACT

A seamless translation method particularly suited to XMPP instant messaging where each user has a unique account with an XMPP service provider. Each unique account is associated with a mobile device and has a preferred language selected. When a sender sends a message in their preferred language the message is sent to the XMPP server to deliver the message where the recipients are identified along with their preferred language. The XMPP server sends the message to a third party translation service that translates the message into the preferred. language of the recipient. The XMPP server then delivers the translated message to the intended recipient.

### BACKGROUND OF THE INVENTION

1. Field of the Invention

The present invention relates to digital communications, and more particularly, to a translating system for allowing better communications between users preferring different languages.

2. Description of the Related Art

Several designs for translation systems have been designed in the past. None of them, however, include a real-time, translation of a typed message after sending and before receipt, automatically in the preferred language of the recipient. Further, the present system allows multiple users in a group or batch communication to each send and receive in their preferred language.

Applicant believes that the closest reference corresponds to U.S. Pat. No. 7,849,144 issued to Prajapat. However, it differs from the present invention because, among other features, the present invention can simultaneously work with multiple parties to a group instant message, each communicating by sending in their preferred language that is translated according each individually of multiple recipients while also translating incoming messages in any language into the preferred language of the reader or recipient.

Other patents describing the closest subject matter provide for a number of more or less complicated, features that fail to solve the problem in an efficient and economical way. None of these patents suggest the novel features of the present invention.

### SUMMARY OF THE INVENTION

It is one of the main objects of the present invention to provide a communications enhancing system that permits users writing in any language to seamlessly send to plural recipients, each receiving in their own preferred language.

It is another object of this invention to provide the system as described above that further allows the reader to receive and read a language that was sent in another language by translating on the fly.

It is yet another object of this invention to provide such a system that is inexpensive to manufacture and maintain while retaining its effectiveness,

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a flow chart of an example of a one to one chat process.

FIG. 2 shows a flow chart of an example of a group chat process.

### DETAILED DESCRIPTION OF THE PREFERRED EMBODIMENT

Text messaging services such as those characterized as being XMPP or XMPP based are commonplace today. XMPP is an open protocol for real-time communication that allows the exchange of text between complying connections.

XMPP as used on modern mobile phones originated from radio telegraphy in radio memo pagers using standardized phone protocols. XMPP was later defined as part of the Global System for Mobile Communications (GSM) series of standards in as a means of sending messages of up to one hundred sixty characters to and from GSM mobile handsets. Since then, support for XMPP has expanded to include other mobile technologies such as ANSI CDMA networks and Digital AMPS, as well as satellite and landline networks. XMPP messages can be mobile-to-mobile text messages, web chats and computer chat clients, although the standard supports several other types of broadcast messaging as well.

Extensible Messaging and Presence Protocol (XMPP) is a communications protocol for message-oriented middleware based on XML (Extensible Markup Language). Unlike some instant messaging protocols, XMPP is an open standard and uses an open systems approach of development and application.

Referring now to the drawings, where the present invention is generally shown in figure one. It can be observed that it includes two users of cell phone text messaging services communicating with each other where each user prefers a different language of communication. In this example User 1 is the sender and prefers English while User 2 is the receiver and prefers to communicate in Chinese. Of course this is merely an example of languages and is meant to include most other common written languages.

Still referring to figure one, in this version of the system, a sender in step one creates a message and delivers it to a translation server. Translation servers are commercially available. Today, there are translation servers maintained by entities such as Google and Microsoft. Continuing on in the process, the translation server translates the message into the language selected by User 2 and returns the translated message to User 1's mobile device without more input from User 1.

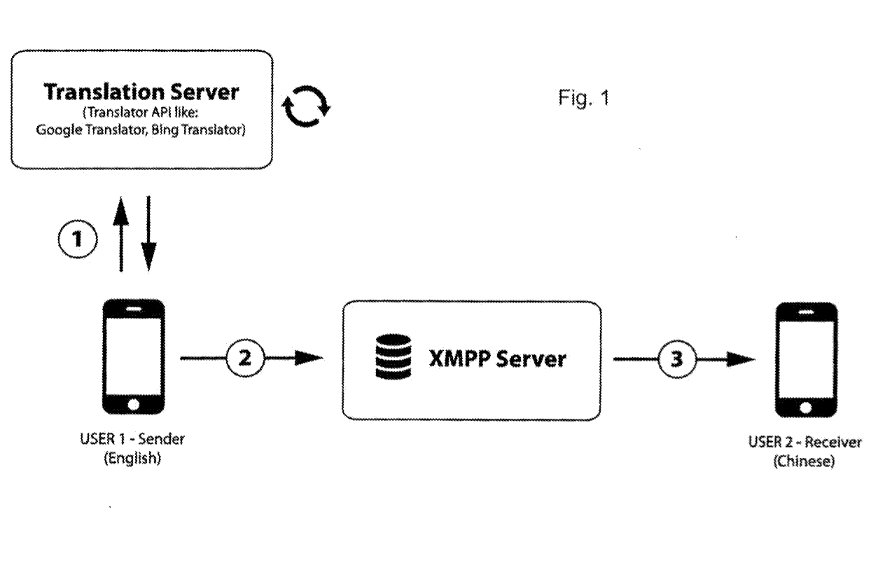

In step two of the process as depicted in FIG. 1. the message, now translated, is forwarded to the XMPP server where it is in turn delivered to User 2 in step three. In this manner the message that originated with User 1 in English on their device is seamlessly translated and sent to User 2 in Chinese, the favored language of User 2.

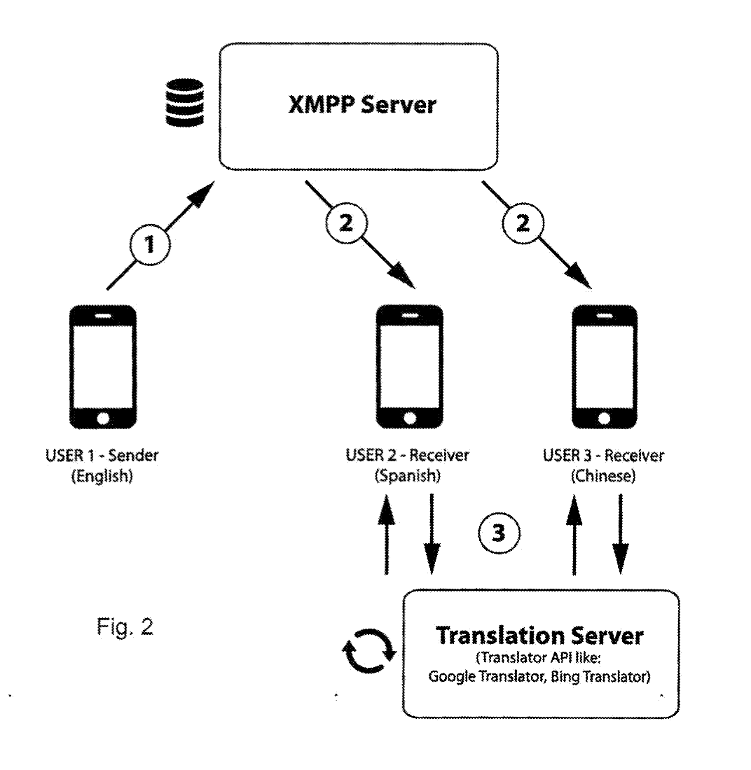

Now referring to FIG. 2, where a group chat process is depicted. In this scenario there is an English preferring User 1 who is sending a message to two others: User 2 and User 3. User 1 has indicated with their service provider a preference to communicate in English; User 2 in Spanish; and User 3 in Chinese.

In this version in FIG. 2, User 1 drafts a message and designates User 2 and User 3 as recipients then transfers the message to the XMPP server. The XMPP server receives the text message and directs it to User 2 and User 3. User 2's device recognizes that the preferred language of the message that it has just received is English and without displaying the message in English User 2's device automatically forwards the content of the text message to a preselected translation server where it is translated into their preferred language. In this example the originally English message is displayed on User 2's phone in Spanish as if the message were drafted by User 1 in Spanish. Similarly, User 3's phone recognizes that the incoming message is in

English but User 3's device is set to display only Chinese. When the message from User 1 is received it is not immediately displayed on User 3's device but is instead delivered first to a preselected translation server where the message is translated into Chinese, redelivered to User 3 where it is displayed in translated form.

An important advantage of the translation server managed by a third party, such as Google or Microsoft is that they are responsible for the continuing improvement and maintenance of the translation system. Translations must take into account slang, phrases and colloquialisms that alter the intended meaning of the text beyond what the simple order of the words would reveal.

In this sense it results in a more robust and accurate translation system to rely on third party managed resources to handle the translation. Further, with the myriad of languages that are in use around the world today it truly is a monumental task to accurately translate the messages. The mechanics of the translation is beyond the scope of the presently disclosed invention.

An important version of the invention can be fairly described as an instant messaging translating service comprised of an XMPP server, a translation service, a sender and a recipient. The sender and the recipient each include an internet enabled mobile device unique to the respective sender and recipient. The sender has a first unique account with said XMPP server and said recipient has a second unique account with said XMPP server. The first unique account has a preferred language setting and said second unique account has a preferred language setting. When the sender sends a discrete XMPP message to the recipient, the XMPP server receives the message and then identifies the preferred language setting in the second unique account then sends the message to the translation service where the message is translated into the preferred language of the second unique account then the translated message is returned to the XMPP server with information identifying the recipient then the translated message is delivered by the XMPP server to the recipient's mobile device where the message is displayed in a readable format.

In an important variation of this version it can be further characterized in that a single sender may simultaneously send a message to a plurality of unique recipients each with a unique account with the XMPP server and each recipient receives the message translated into their own preferred language as identified by the language setting in their respective unique accounts with the XMPP server.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An instant messaging translating service comprised of an XMPP server, a translation service, a sender and a recipient;
said sender and said recipient each include an internet enabled mobile device unique to the respective sender and recipient;
said sender has a first unique account with said XMPP server and said recipient has a second unique account with said XMPP server;
said first unique account has a preferred language setting and said second unique account has a preferred language setting;
when the sender sends a discrete XMPP message to the recipient the XMPP server receives said message then identifies the preferred language setting in the second unique account then sends the message to the translation service where the message is translated into the preferred language of the second unique account then the translated message is returned to the XMPP server with information identifying the recipient then the translated message is delivered by the XMPP server to the recipient's mobile device where the message is displayed in a readable format.

2. An instant messaging translating service as disclosed in claim 1 further characterized in that a single sender may simultaneously send a message to a plurality of unique recipients each with a unique account with the XMPP server and each recipient receives the message translated into their own preferred language as identified by the language setting in their respective unique accounts with the XMPP server.
